(19) United States
(12) Patent Application Publication
(10) Pub. No.: US 2020/0285593 A1
(43) Pub. Date: Sep. 10, 2020

(54) CACHE MANAGER

(71) Applicants: Richard Phillip Mayo, Bristol (GB); Michael John Dowdle, Bristol (GB)

(72) Inventors: Richard Phillip Mayo, Bristol (GB); Michael John Dowdle, Bristol (GB)

(21) Appl. No.: 16/291,738

(22) Filed: Mar. 4, 2019

(51) Int. Cl. G06F 12/128; G06F 12/0815; G06F 9/52; G06F 9/38; G06F 12/0888

(52) U.S. Cl. CPC G06F 12/128; G06F 12/0815; G06F 12/0888; G06F 9/38; G06F 9/52

(57) ABSTRACT

In one example, a processor executes computer-readable instructions that cause the processor to: for each of a plurality of buckets of a data structure stored in a cache of a computer system, execute a first thread such that: a plurality of entries stored in the bucket are inspected to identify a respective entry for removal from the cache based on respective usage metrics of the entries of the bucket, wherein each entry comprises a container of data chunks, access is restricted to the bucket by at least a second thread during the inspection of the respective entries from the bucket by the first thread, one entry of the identified entries is selected for removal from the cache based on a comparison between the respective usage metrics of the identified entries, and the processor enables concurrent access to the plurality of buckets by multiple threads requesting access to the cache, whereby a thread can access and inspect one of the buckets and, during the inspecting, at least one other thread can access another or others of the buckets.

### BACKGROUND

Certain computer systems may generate and store large amounts of data. It is common for data storage for such computing systems to comprise multiple data storage devices. In some cases, a portion of data may be stored in a particular storage component of the computer system for more efficient access. In such examples, the operating system of the computer system may control which data is stored in the local storage component.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic diagram of a system, according to an example.

FIG. 2 is a schematic illustration of a multithread environment, according to an example.

FIG. 3 is a schematic illustration of the cache of FIG. 1, according to an example.

FIG. 4 is a schematic illustration representative of an entry of a bucket, according to an example.

FIG. 5 is a schematic illustration representative of the cache of FIG. 1, according to an example.

FIG. 6 is a flowchart of a method for updating a cache memory, according to an example.

FIG. 7 is a flowchart depicting a method providing further detail to the method of FIG. 6, according to an example.

FIG. 8 is a schematic illustration of a first bucket of the cache memory, according to an example.

FIG. 9 is a schematic representation of a plurality of buckets, according to an example.

### DETAILED DESCRIPTION

Many computing systems demand efficiency, easy accessibility, and scalability in their storage devices. An example computer system may manage access to data stored in persistent storage (e.g., one or more non-volatile storage devices, such as a hard disk drives (HDDs), solid state drives (SSDs), or the like, or a combination thereof) of the computer system using a cache (e.g., implemented by one or more memory devices, such as dynamic random access memory (DRAM) devices, or the like) to store a subset of the data for faster access than from the persistent storage. This may reduce the latency of accessing the data by reducing the frequency of accessing the data from higher-latency persistent storage.

During a data deduplication process, a computer system may receive and analyze an incoming stream of data to determine whether any of the incoming data matches already stored data. In one example, the incoming data stream may be split into chunks (e.g., fixed or variable sized units of the data, such as 4 KB units of the data) and a fingerprint (e.g., a hash or another suitable representation) of each chunk may be used as the basis for such determination by comparing the fingerprint with the fingerprints of previously stored data chunks.

Data chunks stored in the computer system may be stored in respective collections of chunks referred to herein as “containers” that store a plurality of chunks. In some examples, these containers of data chunks may be stored in persistent storage of the computer system, and a subset of the containers may be stored in a cache of the computer system (i.e., “cached”) to reduce the frequency of retrieving containers from higher-latency persistent storage Since the cache may not have sufficient space to store all of the containers, the efficiency of the data deduplication process is dependent in part on which containers are stored in the cache.

In some example computer systems, the subset of data stored in a cache may be dynamically updated to correspond to data that is most accessed or most recently accessed in the computer system (e.g., by threads executed by the computer system). For example, a computer system may store containers of data chunks in persistent storage, cache a subset of the containers, and dynamically update which of the containers are stored in the cache. In such examples, threads executing on the computer system may be carrying out a matching assessment of incoming data chunks as part of a deduplication process using the containers.

In some computer systems, a cache may store data in a data structure such as an array and rely on the use of a lookup operation to access specific data items. A brute-force lookup strategy may be used to access such data in an array structure, but such a strategy may be time-consuming. In other computer systems, a cache may store data in a data structure such as a binary search tree, for example a red-black tree. In such cases, the tree may be traversed to access specific data. However, for each of these example data structures, accessing data (e.g., retrieving or updating the data) in the data structure in the cache may utilize a lock on the data structure to block concurrent access to the data structure (e.g., for consistency). However, such locking may cause contention in a multithread environment between multiple threads requesting access to the data structure.

Accordingly, such locking can increase inefficiencies, resulting in a slowdown in the operation of the computer system, for example, during a deduplication process. Examples described herein may address these problems and enable concurrent access by multiple threads to data stored in the cache to thereby reduce contention between the execution of multiple threads requesting access to the data structure in the cache. Examples described herein may also enable concurrent access to the data structure by a cache management process that may dynamically update what data is stored in the cache. In this manner, examples described herein may make the concurrent access and manipulation of the data structure holding data in the cache of a computer system more efficient. For example, examples described herein may increase the efficiency of execution of multiple threads requesting access to the data structure by enabling multiple different threads to access the data structure concurrently. For example, for a deduplication process as described above, examples described herein may enable a first thread to access a first container in the data structure in the cache and enable a second thread to access another container in the data structure of the cache concurrently. Also, examples described herein may maintain and utilize a global usage criterion (or measure) for containers stored in the data structure of the cache. Accordingly, examples described herein may enhance the performance of the computing system.

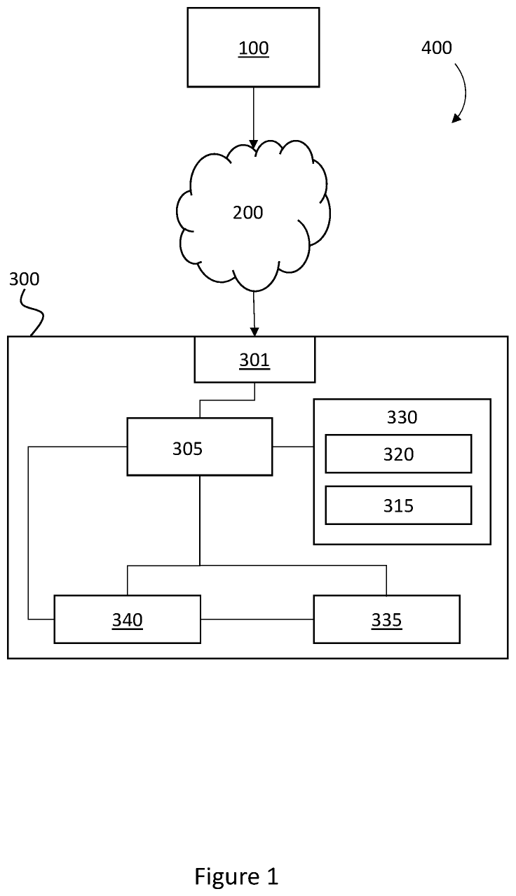

FIG. 1 is a schematic diagram of a system 400. The system 400 has a data source 100 communicatively coupled to a computer system 300 via a network 200.

The data source 100 may provide a stream of incoming data to the computer system 300 over the network 200.

The computer system 300 has an input/output interface 301 through which the computer system 300 receives and transmits data via the network 200.

The input/output interface 301 is coupled to at least one processor 305, such as at least one central processing unit (CPU). The processor 305 may execute machine readable instructions stored in the computer system in at least one machine-readable storage medium 330.

The processor 305 is coupled to a cache 340 (which may be implemented by one or more memory devices, such as DRAM devices, or the like) and persistent storage 335 (which may be implemented by one or more non-volatile storage devices, such as HDDs, SSDs, or the like, or a combination thereof).

Memory management within the computer system 300 may be implemented by processor 305 executing machine-readable instructions such as cache manager instructions 320 to manage the cache 340 and a persistent storage manager instructions 315 to manage persistent storage 335. The machine-readable instructions are stored in a computer readable medium 300 that is coupled to the processor 305.

Cache 340 may be directly coupled to processor 305, and, in some cases, may be located on the same chip as processor 305 or embedded within the processor 305. The cache 340 may temporarily hold information obtained from or to be stored in the persistent storage 335 and may provide faster access to said information than the persistent storage 335 (e.g., due to lower-latency access speeds). In one example, the cache 340 may be divided into a plurality of cache levels, such as a primary cache and a secondary cache. In one example, the cache 340 may be random access memory (RAM).

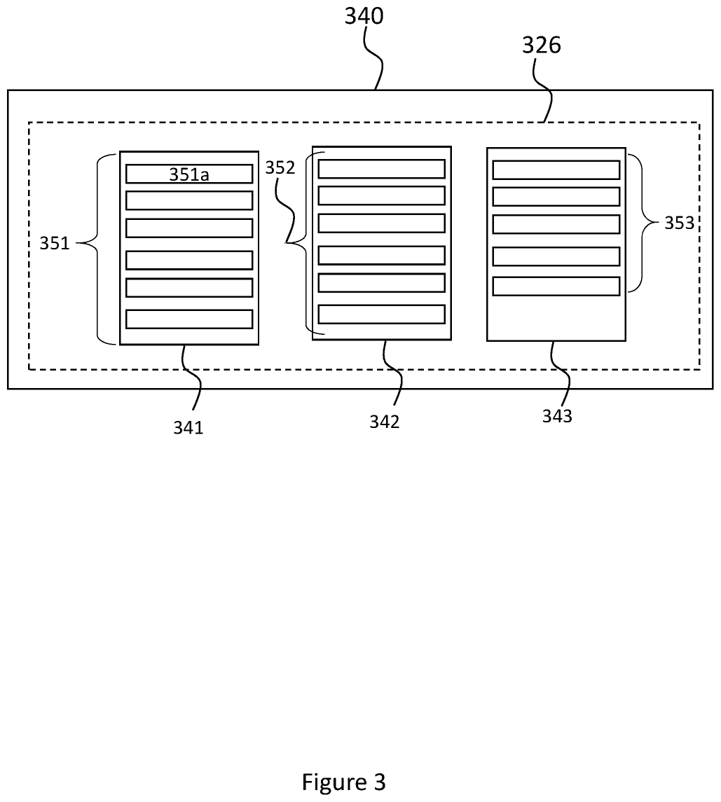

The cache manager instructions 320 (execution thereof results in implementation of a cache manager software component) may define a data structure (FIG. 3, 260) associated with the cache 340 and that may be concurrently accessed and/or manipulated by multiple threads.

The cache manager instructions 320 and the persistent storage manager instructions 315 may update the information stored by the cache 340 by performing read and write operations to and from the cache 340 and the persistent storage 335 in order to allocate relevant, for example, recently accessed, data to the cache memory 340.

As part of execution of a deduplication application by the processor 305, the cache manager instructions 320 may analyze an incoming data stream and compare the fingerprints of chunks of the incoming data stream to fingerprints of data chunks previously stored in the computer system. The fingerprints of data chunks previously stored in the computer system may be stored in a container index and the container index may map fingerprints of data chunks within a container to a logical addresses within the cache 340. Accordingly, the container index enables a query to locate a desired container at an address within the cache. In one example, the container index may be stored in part of the computer readable medium 330.

If there is no match between fingerprints of the container index for the cache and the fingerprints of incoming data chunks, the persistent storage manager instructions 315 may compare the fingerprints of data chunks of the incoming data stream to fingerprints of data chunks within the persistent storage 335.

If a match is found between fingerprints of incoming data chunks and those corresponding to data chunks stored in containers of either the cache 340 or the persistent storage 335, the incoming data chunks are not stored by the computer system 300 to avoid duplication; instead, the already stored data chunk(s) corresponding to the matched fingerprints may be brought into the cache 340 (if it is not already in the cache) and referenced by means of a pointer or similar using a container index associated with the cache 340.

In addition, the processor 305 may execute a different thread(s) of the deduplication application or a thread(s) of another application that requests access to a container stored in either of the persistent storage 335 or the cache 340. When such threads request to access a container, the cache 340 is checked to determine whether the cache 340 stores the requested container before the persistent storage 335 is checked for the same.

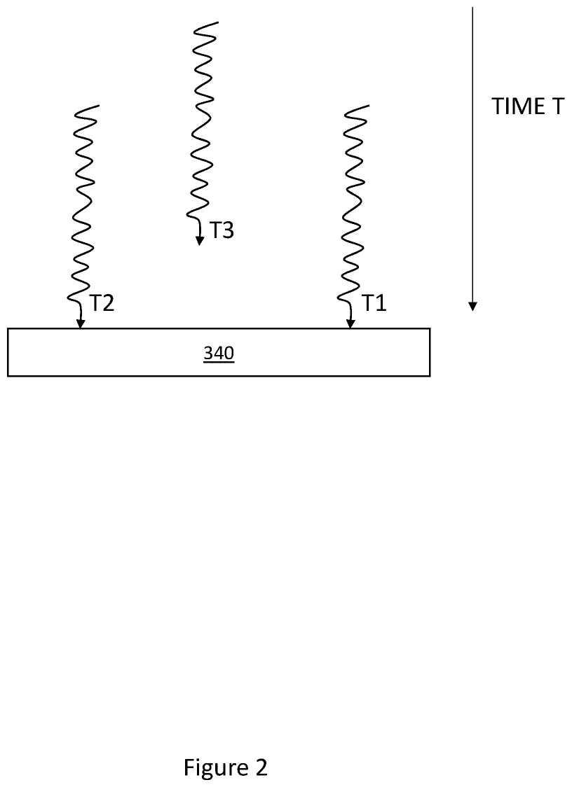

FIG. 2 depicts a simplified representation of a multithread environment in which multiple threads T1, T2 and T3 each request access to containers in cache 340. As indicated by the time, T, arrow, the threads T1 and T2 will concurrently access the cache 340. Thread T3 will request access after threads T1 and T2. Depending on the time required to fully execute the threads T1 and T2, all of the threads T1, T2, and T3 may overlap in accessing the cache 340.

FIG. 3 is a schematic illustration of a data structure 326 stored in cache 340 by cache manager instructions 320 of FIG. 1.

The cache manager instructions 320 defines a data structure 326 comprising a plurality of buckets 341, 342, and 343. In the example of FIG. 3, each of the buckets 341, 342 and 343 may be regarded as a storage unit or space within the data structure 326. In some examples, each bucket is a data buffer that temporarily holds data while the data is moved from one place to another. Each of the buckets 341, 342, and 343 comprises a plurality of entries 351, 352, and 353, respectively. The entries may correspond to containers, which contain a collection of data chunks. For each bucket, cache manager instructions 320 maintain a sorted order of its respective plurality of entries based on identifiers of the entries (e.g., container identifiers, when the entries comprise containers), to enable fast lookup by the identifier. In some examples, each of the entries (such as entry 351a of the plurality of entries 351, for example), may comprise a container of data chunks for deduplication.

In some examples, cache manager instructions 320 may deterministically assign entries to particular buckets 341, 342, 343, respectively, based on the identifiers assigned to the entries, so that the entries are distributed in a deterministic way between the plurality of buckets 341, 342, 343. In one example, the entries may be evenly or near-evenly distributed. In one example, the assigning is a round-robin assignment based directly on the unique identifier. In such an example, all the buckets are considered to be equivalent to one another and each new entry is sequentially assigned to a particular bucket of the buckets 341-343. For instance, a first entry is assigned to the bucket 341 of the buckets 341-343 and a second, subsequent entry is assigned to the bucket 342, where the second bucket may be listed after the first bucket in a list of all the buckets 341-343. In another example, the assigning is a hash-function assignment based on a hash value of the unique identifier. Spreading entries between the buckets reduces the search space for accessing a specific entry within a bucket, which may improve performance of the computer system 300 (FIG. 1).

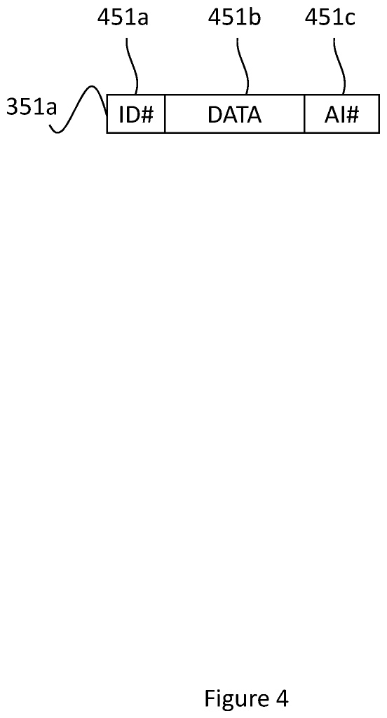

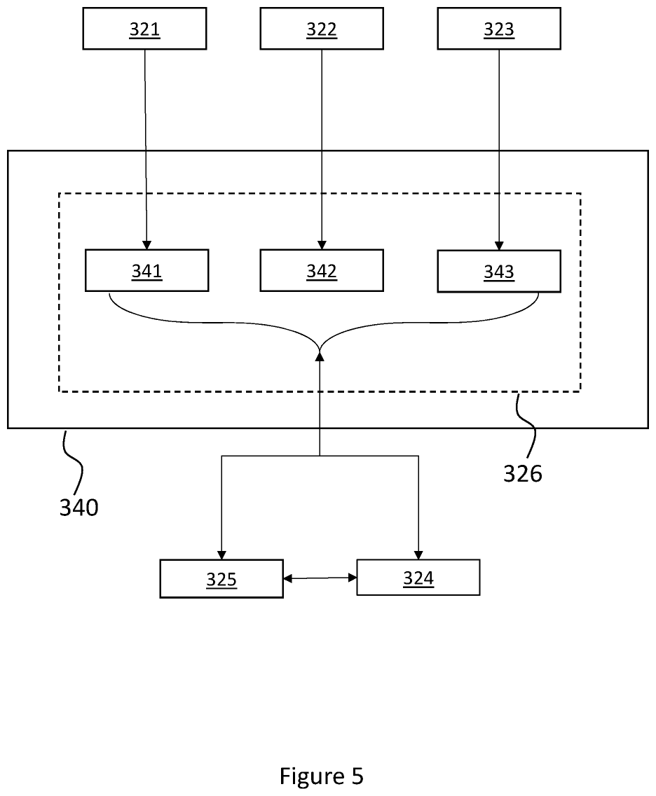

FIG. 4 is a schematic illustration representative of an entry of a bucket, for example an entry 351a of the plurality of entries 351-353. The entry contains an identifier (illustrated as “ID #”) 451a, a container of data chunks 451b (illustrated as “DATA”), and an access indicator or usage metric 451c (illustrated as “AI #”). The identifier ID # of entry 351a is unique to entry 351a and is used to maintain a sorted order of the entry 351a relative to other entries within the same bucket. The access indicator AI # is representative of an access or usage condition of the entry 351a and is assigned to the entry 351a by an access evaluator 324 (discussed below with reference to FIG. 5). In one example, the access indicator is representative of prior usage of the entry in question.

FIG. 5 is another schematic illustration representative of the cache 340, more detailed than the depiction of FIG. 3. The cache manager instructions 320 is used to update the entries stored by the cache 340 based on a global criterion. The updating may involve allocating or de-allocating data to and from a bucket of the cache 340.

As depicted by FIG. 5, the cache manager instructions 320 may implement a plurality of locking mechanisms 321-323, an access evaluator 324, an evaluator lock 325, as well as the data structure 326 of the cache 340, FIG. 3. Each locking mechanism is independently associated with a corresponding bucket of the data structure 326. Specifically, the locking mechanism 321 is associated with bucket 341, the locking mechanism 322 is associated with bucket 342, and the locking mechanism 323 is associated with bucket 343. The one-to-one relationship between the locking mechanisms and the respective buckets improves performance of the computer system 300 (FIG. 1) because individual buckets can be accessed and manipulated concurrently.

Execution of the locking mechanisms 321-323 is initiated by the cache manager instructions 320 to restrict access to its corresponding bucket. This restriction is then released to allow access, independently from the others of the locking mechanisms. In one example, each locking mechanism may enforce a limit to accessing the corresponding bucket, independent from the other locking mechanisms. In one example, each locking mechanism is implemented by execution of a corresponding thread by the cache manager instructions 320.

The cache manager instructions 320 also manages the data stored by the cache 340 in accordance with a global usage criterion. In one example, the global usage criterion is predetermined. As a further example, the global criterion may be a global usage criterion such as a recency of usage criterion (that is, least recently used or most recently used) or a frequency of usage criterion (that is, least frequently used and most frequently used). Accordingly, over time the data stored by the data structure 326 and hence within the cache 340 may be updated to remove (also referred to as evict) entries that no longer meet the relevant predetermined criterion and/or to remove/evict entries upon reaching of a capacity threshold.

In one example, the access evaluator 324 may numerically represent a usage condition relating to the global usage criterion. The access evaluator 324 may be a counter associated with the data structure 326 as a whole, that is, all buckets 341, 342, 343 of the data structure 326 of the cache manager instructions 320. The access evaluator 324 is invoked, and thereby changes its value, when the cache manager instructions 320 is accessed.

In more detail, the access evaluator 324 may increment its value when an entry is inserted into a bucket and when an entry of a bucket is retrieved. As an example, a new entry may be inserted following a new match between a data chunk of an incoming data stream and a data chunk or entry stored within the persistent storage 335. As another example, an entry of the cache 340 may be retrieved following another match with a data chunk of an incoming data stream. In addition, the access evaluator 324 may be controlled to decrement its value when an entry is removed from the cache 340.

The access evaluator 324 may also assign its changed value to the access indicator AI # (FIG. 4) of the entry of the cache manager instructions 320 that is associated with the access request. For example, if entry 351a is retrieved the access evaluator 324 increments its value and assigns said value to the access indicator of entry 351a.

As an example, the predetermined criterion relating to the usage condition of the access evaluator 324 may be a numerical threshold relative to the value of the access evaluator 324. In one case, the access evaluator 324 may numerically represent more recent usage or access to the cache 340 with a higher number. In such a scenario, the predetermined criterion can be a recency of usage criterion having a value below that of the access evaluator, where entries having access indicators with a value less than (or within predetermined distance from) the usage criterion may be identified as candidates for removal from the cache 340.

In one example, an evaluator lock 325 is implemented to globally restrict access to each bucket of the cache manager instructions 320 whilst the access evaluator 324 atomically changes its own value associated with the predetermined criterion and assigns the changed value to an entry within said bucket. In one example, the evaluator lock 325 may block access to each bucket of the cache instructions by any thread. Once the value of the access evaluator 324 has been changed and assigned to an entry the evaluator lock 325 may be released to allow a thread to access the cache manager instructions 320.

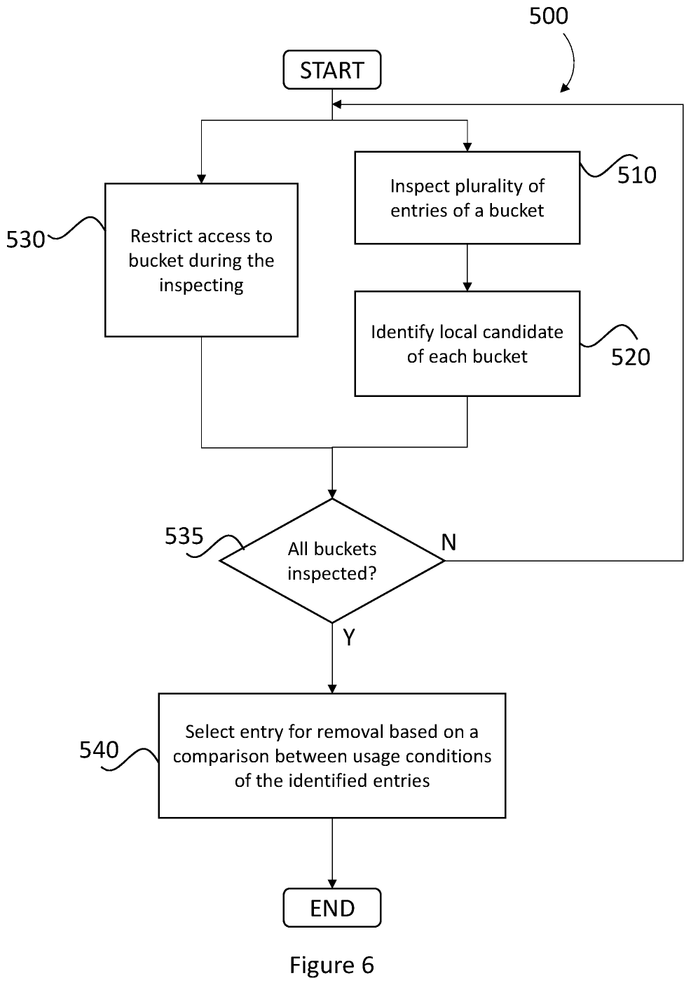

FIG. 6 is a flowchart of a method 500 for updating the cache 340. The cache manager instructions 320 implements the method 500. In particular, the cache manager instructions 320 implements blocks 510-530 for each bucket 341-343 in turn.

At block 510, the plurality of entries 351 of the first bucket 341 are inspected. In one example, the inspecting is an examination of the usage conditions described above of each entry of the bucket in question.

At block 520, following the inspection of block 510, a candidate from the first bucket 341 is identified for removal from the cache 340, where such a candidate may be referred to as a “local” candidate. The local candidate may have a usage condition that satisfies a first predetermined use criterion of the bucket.

At block 530, during the inspecting of block 510, and in some cases, the identifying of block 520, access to the first bucket 341 by at least one other thread is restricted. In one example, the restriction may restrict threads that are not read-only threads. In another example, the restriction may block any other thread from accessing the bucket in question.

At block 535, an assessment is made as to whether all the buckets of the cache 340 have been inspected. If not, the no “N” branch is followed and the method 500 returns to block 510 for other buckets of the cache 340, for example, buckets 342 and 343. In this way, access to the buckets is restricted one bucket at a time at least during the inspecting of block 510. If all the buckets of the cache manager instructions 320 have been inspected, the yes “Y” branch is followed and the method 500 proceeds to block 540.

At block 540, an entry of the cache is selected for removal from the cache 340 based on a comparison between the usage conditions of the respective identified entries. The selected candidate may be referred to as a “global” candidate because said candidate is chosen across all entries from the identified entries that are each local to a corresponding bucket.

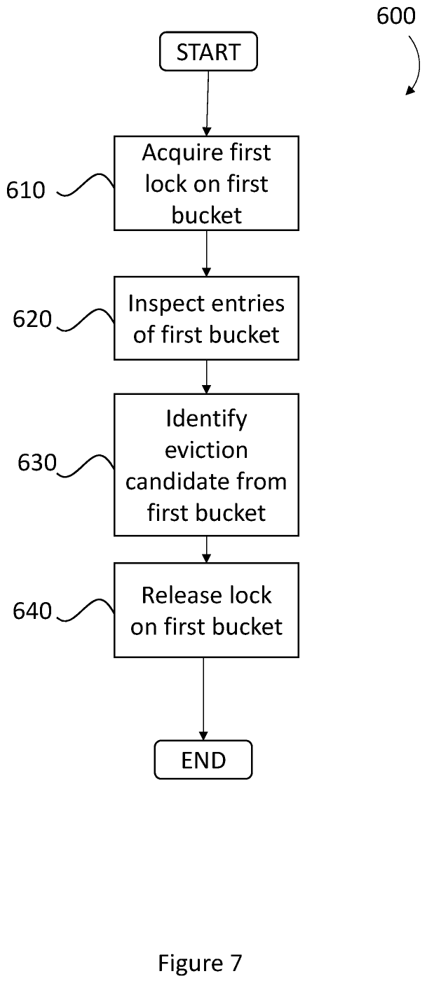

FIG. 7 is a flowchart depicting a method 600, which provides further detail to the interaction between blocks 510, 520 and 530 of method 500 of FIG. 6.

At block 610, a first lock is acquired on the first bucket 341, whereby access to the first bucket by at least one other thread is restricted.

At block 620, the plurality of entries 351 of the first bucket 341 is inspected. Following the inspection, at block 630, a candidate for removal from the cache 340 is identified from the plurality of entries 351.

At block 640, the first lock is released such that access to the first bucket by at least one other thread is no longer restricted. In one example, following the release of the first lock, a second lock, associated with another bucket, for example, the second bucket 342, is acquired, and the inspection and identification are repeated in relation to the second bucket 342, and then for any other buckets of the cache 340.

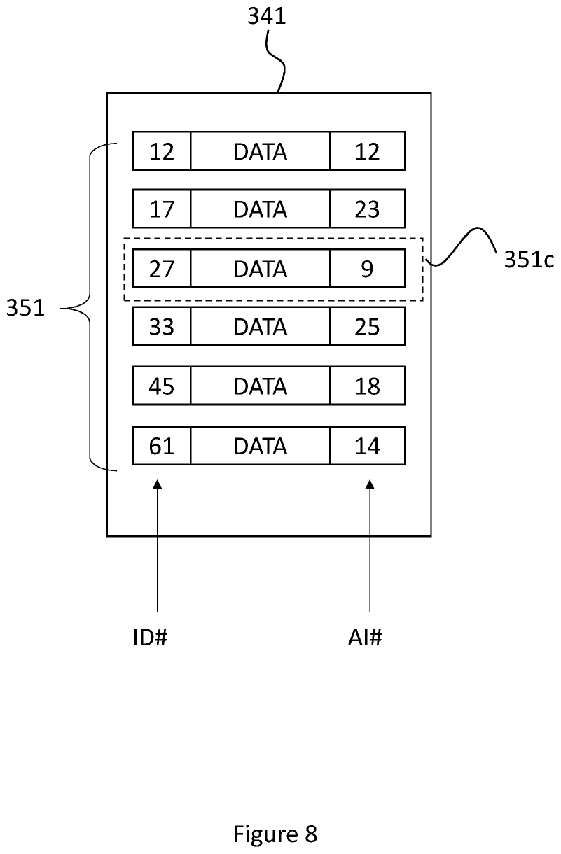

FIG. 8 is a schematic illustration of the first bucket 341 of the cache manager instructions 320. The first bucket 341 has a plurality of entries 351, including an entry 351c. Each entry has an access indicator AI # indicative of a usage condition of said entry. The entry 351c has the lowest value access indicator, which indicates that the entry 351c satisfies a first predetermined use criterion of the bucket 341. Accordingly, the entry 351c is identified (represented by the dashed line) as a local candidate for removal from the cache 340.

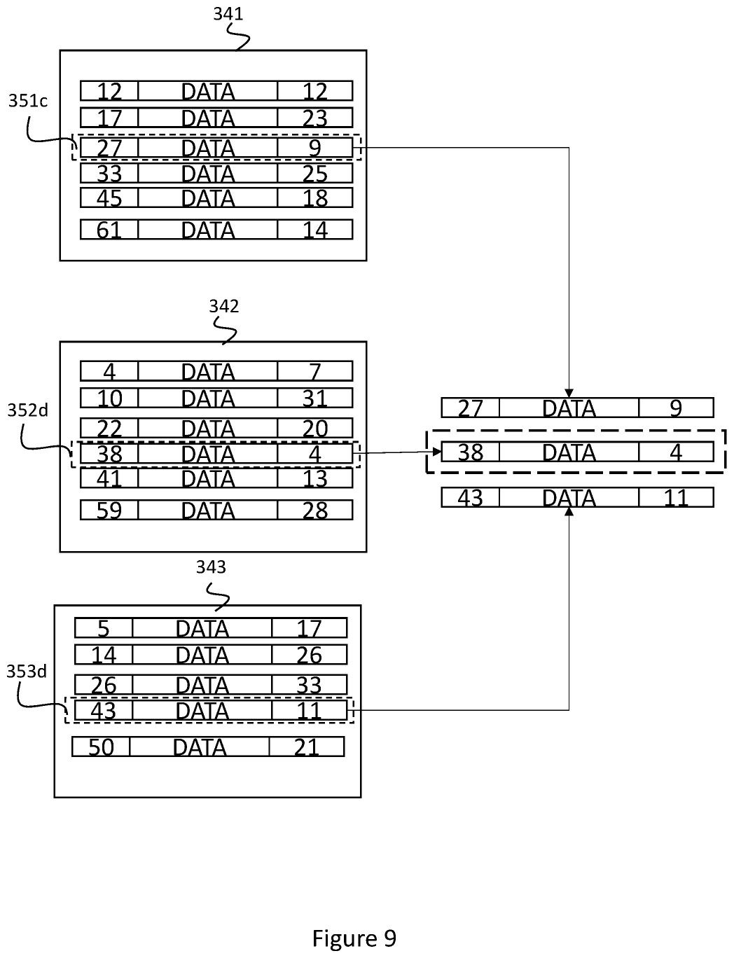

FIG. 9 is a schematic representation of the plurality of buckets 341-343 and their respective local candidates for removal from the cache memory 340. As described above, the local candidate for removal for the first bucket 341 was identified as entry 351c. The local candidate for removal for the second bucket 342 is identified as entry 352d because entry 352d has the lowest value access indicator of the plurality of entries 352. The local candidate for removal for the third bucket 343 is identified as entry 353d because entry 353d has the lowest value access indicator of the plurality of entries 353.

Entry 352d is selected as a global candidate for removal from the cache memory 340 because entry 352d has the lowest value access indicator compared to the other identified local entries 351c and 353d.

After selection of a global candidate for removal, such as entry 352d in the example of FIG. 9, a thread may be executed to return to the bucket containing the global candidate (that is, bucket 342) and remove said entry from the bucket. In this case, the locking mechanism of the bucket in question is acquired for when the thread removes the candidate and, after, is released.

In some cases, it may be determined that the selected entry has already been removed from the memory 340 by another thread (that is, a cache miss). In this scenario, a thread is executed to select another entry from the identified entries to be removed from the memory 340, wherein the another entry is closest to the predetermined use criterion relative to the other identified entries. In one example, the entry selected for removal may have the second lowest value access indicator. In a scenario where all of the identified entries are exhausted, that is, each has already been removed from the cache 340, the method 500 of FIG. 6 is repeated to regather candidates for removal. In another example, such repetition may occur after a threshold number of failed removals (where the selected candidate has already been removed) has been met.

In some examples, it may be determined that multiple threads are independently initiating an inspection of the buckets of the cache 340. In response to such a determination, the multiple threads may be distributed between different buckets from which to initiate the inspections. In one example, the distribution of multiple threads may ensure that each thread inspects the bucket on which it was operating originally. As an example, a thread of a software application implemented by the processor 305, for example, a thread of a deduplication application, may request to retrieve an entry from the cache to perform matching, for instance, with a received data unit. If the entry is not present in the cache 340 (cache miss), for example, if the entry has previously been evicted from the cache 340, the thread attempts to load the entry from the persistent storage 335. Such loading may oversize the cache 340 and require an eviction. In such a scenario, the thread will then perform the inspection of the buckets and the subsequent eviction. In one example, this inspection may start with the bucket that the thread initially requested the entry from.

In some cases, the cache manager instructions 320 may implement a second locking mechanism per bucket to protect the state of the current candidates for removal (as identified in block 520 of method 500) of the respective buckets. In this way, another thread would be allowed to access a bucket to manipulate non-candidate entries. In one example, the second locking mechanism may be a read lock to allow multiple threads to request the candidate for removal concurrently.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A computer readable storage medium comprising computer-readable instructions, that, when executed by a processor of a computer system, cause the processor to:
for each of a plurality of buckets of a data structure stored in a cache of the computer system, execute a first thread to inspect a plurality of entries stored in the bucket to identify a respective entry for removal from the cache based on respective usage metrics of the entries in the bucket, wherein each entry comprises a container of data chunks;
for each of the plurality of buckets, restrict access to the bucket by at least a second thread during the inspection of the respective entries from the bucket by the first thread; and
select, for removal from the cache, one of the identified entries based on a comparison between the respective usage metrics of the identified entries, such that the processor is to:
enable concurrent access to the plurality of buckets by multiple threads requesting access to the cache, whereby a thread can access and inspect entries of one of the buckets and, during the inspecting, at least one other thread can access another or others of the buckets.

2. The computer readable medium of claim 1, wherein execution of the first thread by the processor maintains a usage criterion globally associated with the cache.

3. The computer readable medium of claim 1, wherein each entry is assigned, deterministically, to a specific bucket of the plurality of buckets based on a unique identifier of each entry so that the entries are distributed between the plurality of buckets.

4. The computer readable medium of claim 3, wherein the computer readable instructions cause the processor to insert an entry into its assigned bucket, wherein each entry comprises an indicator having a value indicative of the usage metric of the entry.

5. The computer readable medium of claim 4, wherein insertion of an entry into a bucket results in incrementing of the value of the respective indicator.

6. The computer readable medium of claim 4 or 5, wherein retrieval of an entry from a bucket results in incrementing of the value of the respective indicator.

7. The computer readable medium of any of claim 4, wherein the value of an indicator corresponds to a value of a counter associated with the cache.

8. The computer readable medium of claim 7, wherein the value of each indicator is atomically assigned to the respective entry by the counter.

9. The computer readable medium of claim 2, wherein the usage criterion is a least recently used criterion.

10. The computer readable medium of claim 1, wherein the computer readable instructions cause the processor to remove the selected entry from the cache.

11. The computer readable medium of claim 1, wherein the computer readable instructions cause the processor to:
determine that the selected entry has already been removed from the cache; and
select another entry from the identified entries to be removed from the cache based on the respective usage metrics of the other identified entries.

12. The computer readable medium of claim 1, wherein the computer readable instructions cause the processor to execute the thread to:
restrict access, by the at least one other thread after the inspecting, to the identified entry of the respective bucket.

13. The computer readable medium of claim 1, wherein the computer readable instructions cause the processor to execute the thread to:
determine whether multiple threads are each initiating an inspection of the buckets; and
in response to determining that multiple threads are each initiating an inspection of the buckets, distribute the multiple threads to different buckets from which to initiate the inspections.

14. A method of controlling a cache memory associated with a plurality of buckets, the method comprising:
for each bucket, wherein each bucket comprises a plurality of entries, in response to receiving a first request:
initiating an access limitation on the bucket, whereby the access limitation prevents access to the bucket in response to at least one other request;
during the access limitation, examining the plurality of entries of the bucket and identifying a candidate entry for removal from the cache memory, wherein the identifying is based on prior usage of each of the plurality of entries; and
releasing the access limitation on the bucket; and
determining which of the candidate entries to remove from the cache memory based on a comparison of the respective prior usage of each of the identified entries.

15. A computer system comprising:
a computer readable storage medium;
a processor; and
a cache;
wherein the computer readable storage medium comprises computer readable instructions and the processor is to execute the instructions to cause the processor to, for each of a plurality of buckets of a data structure stored in the cache:
execute a first thread to inspect a plurality of containers stored in the bucket to identify a respective container for removal from the cache based on respective usage conditions of the containers in the bucket, wherein each container comprises data chunks;
restrict access to the bucket by at least a second thread during the inspection of the respective containers from the bucket by the first thread; and
select, for removal from the cache, one of the identified containers based on a comparison between the respective usage conditions of the identified containers.
